(19) United States
(12) Patent Application Publication
(10) Pub. No.: US 2007/0279320 A1
(43) Pub. Date: Dec. 6, 2007

(54) Six segments display and the method of the same

(75) Inventors: Shao-Ming Wu, Taipei (TW); Chen-Chun Lai, Taipei (TW); Hsien-Tang Chen, Taipei (TW)

Correspondence Address: BACON & THOMAS, PLLC, 625 SLATERS LANE, FOURTH FLOOR, ALEXANDRIA, VA, 22314, US

(73) Assignee: Daka Studio, Inc., Taipei (TW)

(21) Appl. No.: 11/445,137

(22) Filed: Jun. 2, 2006

(51) Int. Cl. G09G 3/04

(52) U.S. Cl. 345/34

(57) ABSTRACT

The present invention discloses a display device comprising a microprocessor; seven display elements coupled to an electronic circuit and arranged in a predetermined configuration, wherein the electronic circuit comprises a pulse-generating means and a plurality of switches coupled to the microprocessor respectively, wherein the seven display elements comprise two first display elements controlled by the same switch and five second display elements controlled by a plurality of different switches respectively to represent a six segments display; and a power source coupled to the microprocessor and the electronic circuit.

### BACKGROUND OF THE INVENTION

1. Field of the Invention

The present invention relates to a display device, and more particularly, relates to the display device which may show the Arabic numeral 0 to 9 by the six segments display.

2. Description of the Related Art

Recently, liquid crystals have been developed and employed in transmissive, reflective, or absorptive type flat panel displays utilizable for a light shutter or other applications. So far the classes of liquid crystal materials have been identified to be of three types: the cholesterin, the nematic and the smectic. Of the three types of liquid crystal materials, nematic liquid crystals have properties suitable for use in the device of the present invention. The nematic liquid crystals are further subdivided into two classes, the one is Dynamic Scattering Mode (DSM), and the other is Field Effect Mode (FEM). The Field Effect Mode liquid crystals are further classified into two types, i.e., the one is the liquid crystal with positive dielectric anisotropy and the other is the liquid crystal with negative dielectric anisotropy. Especially, the former one is called as a Twist Nematic Liquid Crystal.

Liquid crystal material requires such a specific voltage value of its own as sufficiently strong enough to excite it in accordance with its property, which is called a threshold voltage. Further, even if a voltage greater than this threshold voltage is applied across the liquid crystal material, it is not until a certain duration of time (referred to as the response time of the liquid crystal) has passed that it is excited to become to the “ON” state. Here is defined respectively terms “ON” to mean the state wherein the liquid crystal is excited to cause a display activity, and “OFF” represents the state wherein it is in quiescent condition and no display activity is performed. Herein, the response time of the liquid crystal means the rising time and the falling time thereof, the rising time represents a length of time when it takes for the liquid crystal to attain to be fully in the excited state by the application of the required voltage, and the falling time is a length of time when it takes for the liquid crystal to be back from the excited state to the quiescent state by the removal of such applied voltage.

The common mode of color liquid crystal display panels is display of white characters on a colored background (hereinafter called “negative display”), because the character region is de-colored by the presence of an applied field. While such a color display panel has the advantages of a very wide viewing angle, sufficient brightness and being fashionable, the display of colored characters on a white background (hereinafter called a “positive display”) would be preferable to a negative display in view of human perception. In order to realize a positive display, a transparent electrode pattern must be designed so that a transition voltage can be applied across the background region of characters. In general, a display area of a display panel consists of unit display areas and background area. Each of the unit display areas can simply be called a segment. As well known, the Arabic numeral 0 to 9 can be shown by making use of seven segments, which are arrayed in a figure eight and which are different from the background area. In the conventional negative display, wanted segments needed for a desired numeral are energized while the background area remains un-energized. In the positive display, however, the background area and unwanted segments are energized while the wanted segments for display remain un-energized.

For a positive display, therefore, the electrode patterns on the front and back substrates must be different from the conventional negative display panel. In a positive display panel of a single digit, for instance, a primitive electrode patters can be thought of as follows. An electrode layer formed on a front substrate is divided into nine sections to provide nine individual electrodes. While seven electrodes are arrayed so as to selectively energize unwanted segments and its outside background, the remaining two electrodes are arrayed to energize only inside backgrounds of the figure eight. On the other hand, a back electrode substrate has eight divided electrodes closely arrayed to each other, and one of which is a so called common electrode to be used for energizing unwanted segments and two inside backgrounds. The common electrode is designed so as to face all segments and two front electrodes used only for the inside backgrounds. The remaining seven electrodes are arrayed so that each electrode faces each seven front electrodes except for the segment areas.

With this positive display panel, a desired numeral can be obtained by selectively applying the transition voltage between front and back electrodes. However, with regard to the number of channels of a driving circuit, sixteen channels in total are required. Moreover, this number is twice as many as the number of channels in the case of the conventional negative display, hence the driving circuit becomes expensive and the driving operation becomes complex. The seven segments display required more space to layout the corresponding circuits and contact pads. Those elements occupied a lot of substrate space, under certain application, it causes a serious limitations.

Therefore, in view of the above-mentioned of the prior art, a new display device may be provided to achieve a purpose of lower occupation and for simplified driving circuit design to overcome the above drawbacks.

### SUMMARY OF THE INVENTION

In view of the drawbacks of prior art, which cost and number of the driving circuit of the conventional display becomes expensive and larger and the driving operation becomes complex, the present invention provides a new display device with a six segments display for saving numerals of control circuits of the display elements.

In accordance with the purpose of the present invention, the invention provides a display device comprising a microprocessor; seven display elements coupled to an electronic circuit and arranged in a predetermined configuration, wherein the electronic circuit comprises a pulse-generating means and a plurality of switches coupled to the microprocessor respectively, wherein the seven display elements comprise two display elements controlled by an identical switch and five individual display elements controlled by a five independent switches respectively to represent a six segments display; and a power source coupled to the microprocessor and the electronic circuit.

The six segments display can show the Arabic numeral 0 to 9, wherein seven is represented by a specific symbol defined by a specified combination of the six segments display.

The display device comprises a liquid crystal display device, wherein each one of the display elements comprises a layer of liquid crystal material arranged between a pair of electrode plates.

The pulse-generating means is adapted to generate a plurality of drive pulse signals for exciting the liquid crystal material to selectively turn the display elements ON and OFF and a plurality of control pulses for operating the switch.

The switch is adapted to select one of the drive pulse signals to each electrode plate of the pair of electrode plates, and the selected drive pulses is combined to produce a plurality of combined pulses.

According to another aspect of the present invention, the combined pulses comprises two different pulse combinations, one of the pulse combinations above the threshold value of the liquid crystal material in effective voltage and another of the pulse combinations below the threshold value of the liquid crystal material in effective voltage.

The display device comprises, but not limited to, an electronic game device with any game module, a mobile phone, a computer, a calculator, a cash register, a thermometer, an electronic clock, a scanner, a projector, or a PDA (Personal Digital Assistant).

### BRIEF DESCRIPTION OF THE DRAWINGS

For a better understanding of the present invention and to show how it may be carried into effect, reference will now be made to the following drawings, which show the preferred embodiments of the present invention, in which:

FIG. 1 shows a display device according to the present invention.

FIG. 2 shows a view of a display element with a six segment display.

### DESCRIPTION OF THE PREFERRED EMBODIMENTS

In the following description, numerous specific details are set forth in order to provide a thorough understanding of the present invention, and the scope of the present invention is expressly not limited expect as specified in the accompanying claims. One skilled in the relevant art will recognize, however, that the invention may be practiced without one or more of the specific details.

Those of ordinary skill in the art will immediately realize that the embodiments of the present invention described herein in the context of methods and schematics are illustrative only and are not intended to be in any way limiting. Other embodiments of the present invention will readily suggest themselves to such skilled persons having the benefits of this disclosure.

The present invention discloses a display device which is utilized a six segments display to show the Arabic numeral 0 to 9, wherein the numeral 7 (seven) is represented by a specific symbol defined by a specified combination of the six segments display. The Arabic numeral 1 to 9 shown in the display may be used for any kind of displaying. Generally, the aim of the digit display is to enter a numeral from 1 (one) through 9 (nine) in each block.

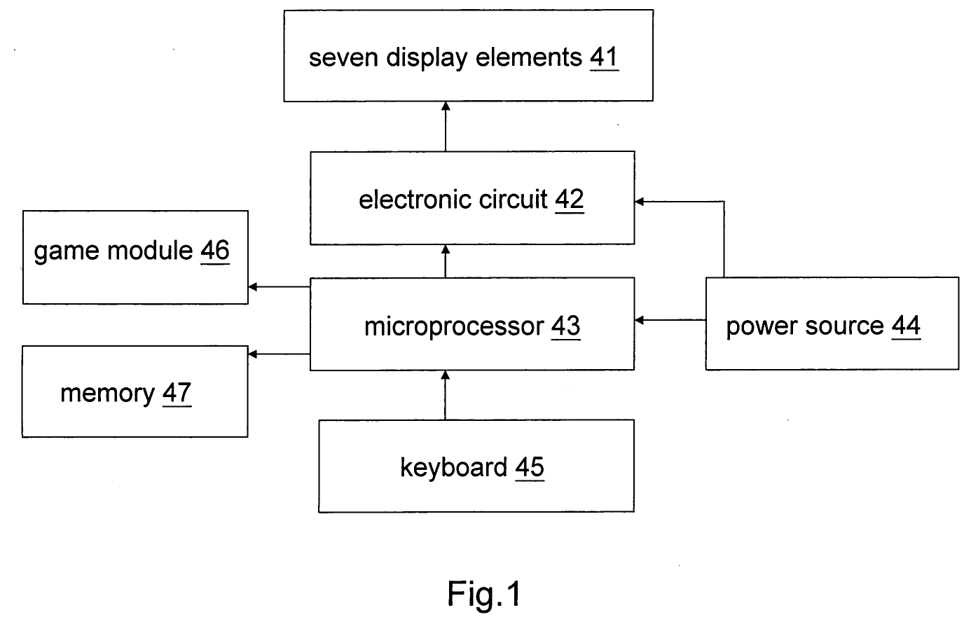

Referring to FIG. 1, it shows a display device according to the present invention. The display device comprises seven display elements 41, an electronic circuit 42, a microprocessor 43, a power source 44, a keyboard 45, and a memory 47. The seven display elements 41 constitute a display unit. In one embodiment, the display device of the present invention comprises a plurality of the display units, and the seven display elements 41 may be disposed on the main body. For example, the display elements 41 are LCD display. In another embodiment, the display device of the present may be an electric game device with any kind of game module, a mobile phone, a computer, a calculator, a cash register, a thermometer, an electronic clock, a computer, a scanner, a projector or a PDA (Personal Digital Assistant). The memory 47 may store data of user's name or play record etc.

The microprocessor 43 may be disposed into the main body, and coupled to the power source 44. The microprocessor 43 may be coupled to a game module 46. The game module 46 comprises a program for generating an electronic game. The electronic circuit 42 may be disposed into the main body, and coupled to the microprocessor 43, the seven display elements 41 and the power source 44. The electronic circuit 42 comprises a pulse-generating means and a plurality of switches coupled to the microprocessor 43 respectively. For example, the display element 41 comprises a layer of liquid crystal material arranged between a pair of electrode plates. The pulse-generating means is adapted to generate a plurality of drive pulse signals for exciting the liquid crystal material to selectively turn the display elements 41 ON and OFF and a plurality of control pulses for operating the switch. Moreover, the switch is adapted to select one of the drive pulse signals to each electrode plate of the pair of electrode plates, and the selected drive pulses is combined to produce a plurality of combined pulses. The combined pulses comprise two different pulse combinations, one of the pulse combinations above the threshold value of the liquid crystal material in effective voltage for a positive display, and another of the pulse combinations below the threshold value of the liquid crystal material in effective voltage for a negative display.

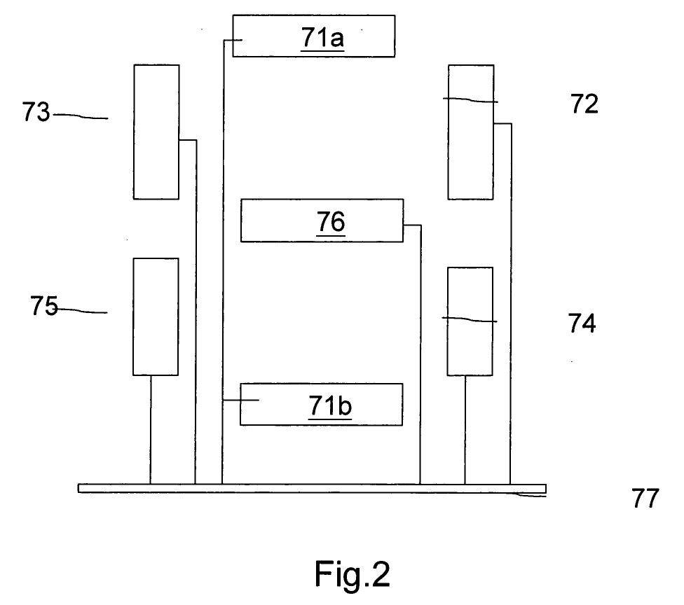

In the present invention, the seven display elements 41 are arranged in a predetermined configuration, shown in FIG. 2. The seven display elements 41 comprise two display elements 71a, 71b controlled by the same switch and five display elements 72, 73, 74, 75 and 76 controlled by five independent switches respectively. In one embodiment, the display elements 71a, 71b are connected, parallelly. Preferably, they are the upper and the lower segments. Namely, they will be turn on or off, simultaneously. The display elements 71a, 71b, 72, 73, 74, 75 and 76 are coupled to a common electrode 77. The display elements 71a, 71b are controlled by the same switch, and therefore the seven display element 41 constitutes a six segments display. In one embodiment, the numeral 7 (seven) may be represented by combination of the display elements 76, 74 or combination of the display elements 71a, 71b, 73, 75 and 76.

The seven display elements 41 may be shown the data of executing by the microprocessor 43 through the electronic circuit 42 coupled to the seven display elements 41. The microprocessor 43 is coupled to the power source 44 and the keyboard 45 such that the power source 44 can provide a power source to the microprocessor 43 and seven display elements 41 through the electronic circuit 42.

As above-mentioned, the seven display elements 41 are shown by the six segments display such that the display device of the present invention can reduce numerals and the occupied space of the electronic circuits and therefore simplify the driving circuit design. Specifically, the present invention may use lower counts to achieve the purpose that has to be done by higher counts. For example, in 4×4 cells conventional Sudoku game device, it needs 112 (4×4×7=112) control circuits. In the present invention, in 4×4 cells Sudoku game device, it only needs 96 (4×4×6=96) control circuits within 100. In another embodiment, in 9×9 cells conventional Sudoku game device, it needs 567 (9×9×7=567) control circuits. In the present invention, in 9×9 cells Sudoku game device, it only needs 486 (9×9×6=486) control circuits within 500. Accordingly, display device with a six segments display is enormously reducing numerals of control circuits of the display elements

Therefore, in contrast with the prior art having some drawbacks, the present invention provides a new display device which may achieve a purpose for saving numerals of control circuits of the display elements and overcome the above drawbacks.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A display device with a six segments display, comprising:
a microprocessor;
an electronic circuit, wherein said electronic circuit comprises a pulse-generating means and a plurality of switches coupled to said microprocessor respectively;
seven display elements coupled to said electronic circuit and arranged in a predetermined configuration, wherein said seven display elements comprise two display elements controlled by one of said plurality of switches and other five independent display elements controlled by remaining five switches of said a plurality of switches respectively to represent said six segments display; and
a power source coupled to said microprocessor and said electronic circuit.

2. The device as in claim 1, wherein said six segments display can show the Arabic numeral 0 to 9.

3. The device as in claim 1, wherein said display device comprises a liquid crystal display device.

4. The device as in claim 3, wherein each said liquid crystal display device comprises a layer of liquid crystal material arranged between a pair of electrode plates.

5. The device as in claim 1, wherein said pulse-generating means is adapted to generate a plurality of drive pulse signals for exciting liquid crystal material to selectively turn each one of said seven display elements ON and OFF and a plurality of control pulses for operating said plurality of switches.

6. The device as in claim 5, wherein said plurality of switches are adapted to select one of said drive pulse signals to each electrode plate of said pair of electrode plates, said selected drive pulses being combined to produce a plurality of combined pulses.

7. The device as in claim 6, wherein said combined pulses comprise two different pulse combinations, one of said pulse combinations above the threshold value of said liquid crystal material in effective voltage and another of said pulse combinations below the threshold value of said liquid crystal material in effective voltage.

8. The device as in claim 1, wherein said display device comprises an electronic game device, a mobile phone, a calculator, a cash register, a thermometer, an electronic clock, a computer, a scanner, a projector or a PDA (Personal Digital Assistant).

9. The device as in claim 1, wherein said display device comprises a memory.
